(19) United States
(12) Patent Application Publication
(10) Pub. No.: US 2013/0085634 A1
(43) Pub. Date: Apr. 4, 2013

(54) CONTROL APPARATUS FOR HYBRID VEHICLE

(71) Applicant: Yoshitaka JINBO, Tokyo (JP)

(72) Inventor: Yoshitaka JINBO, Tokyo (JP)

(73) Assignee: Fuji Jukogyo Kabushiki Kaisha, Tokyo (JP)

(21) Appl. No.: 13/610,527

(22) Filed: Sep. 11, 2012

(30) Foreign Application Priority Data
Sep. 30, 2011 (JP) 2011-215871

(51) Int. Cl. B60W 20/00

(52) U.S. Cl. 701/22; 180/65.275; 903/903

(57) ABSTRACT

There is provided a control apparatus for hybrid vehicle. A motor/generator and a drive wheel are connected via a power transmission path. Further, an engine is connected to the power transmission path via a friction clutch. An EV mode using the motor/generator is implemented by disengaging the friction clutch, whereas an HEV mode using the motor/generator and the engine is implemented by engaging the friction clutch. When the engine is started in order to shift to the HEV mode during travel in the EV mode, the engine is rotated by a starter motor, and damping torque Tm2 is output from the motor/generator. Damping torque Tm2′ is then transmitted to the engine via the friction clutch, which is set in a slip condition.

### CROSS-REFERENCE TO RELATED APPLICATIONS

The present application claims priority from Japanese Patent Application No. 2011-215871 filed on Sep. 30, 2011, the entire contents of which are hereby incorporated by reference.

### BACKGROUND OF THE INVENTION

1. Field of the Invention

The present invention relates to a control apparatus for a hybrid vehicle in which a drive wheel is driven using an engine and a travel motor.

2. Description of the Related Art

A hybrid vehicle in which a clutch is incorporated into a power transmission path of an engine, enabling travel using a travel motor alone, has been developed. In this type of hybrid vehicle, a travel condition is determined on the basis of a vehicle speed and an accelerator opening, and the engine and travel motor are controlled in accordance with the travel condition. In a low vehicle speed region where the accelerator opening is small, for example, a drive wheel is driven using the travel motor and the clutch is disengaged in order to stop the engine. As a result, an amount of fuel consumed by the engine is suppressed. In a high vehicle speed region where the accelerator opening is large, on the other hand, the clutch is engaged by starting the engine such that the drive wheel is driven using both the engine and the travel motor. As a result, a sufficient power performance is secured.

In this type of hybrid vehicle, the engine is started frequently in accordance with the travel condition, and it is therefore important, from the viewpoint of improving vehicle quality, to suppress vibration during engine startup. For this purpose, there has been developed a hybrid vehicle in which an engine is cranked by gradually engaging a clutch provided between a travel motor and the engine when the engine is started during motor travel, and once an engine rotation speed has reached a startable rotation speed, an engagement force of the clutch is maintained (see Japanese Unexamined Patent Application Publication (JP-A) No. 2005-162142, for example). By controlling the clutch in this manner, engine vibration during cranking can be blocked by the clutch, and as a result, vibration that propagates from the engine to a vehicle body via a drive system can be suppressed.

However, vibration that proves problematic during engine startup includes not only the vibration that propagates from the engine to the vehicle body via the drive system, but also vibration that propagates from the engine to the vehicle body via an engine mount. In other words, to ensure that vibration occurring during engine startup is suppressed sufficiently, the engine vibration itself is preferably suppressed rather than simply blocking the engine vibration transmission path to the vehicle body. Further, when the engine is cranked using the travel motor, as in the hybrid vehicle of JP-A No. 2005-162142, a starting torque of the engine must be added to an output torque of the travel motor in order to avoid a sensation of deceleration during motor travel, and as a result, a size of the travel motor may increase.

### SUMMARY OF THE INVENTION

An object of the present invention is to suppress vibration occurring during engine startup while avoiding an increase in a size of a travel motor.

An aspect of the present invention provides a control apparatus for a hybrid vehicle in which a drive wheel is driven using an engine and a travel motor, including: a starter motor that causes the engine to start rotating; a power transmission path that transmits power from the travel motor to the drive wheel; a friction clutch that is provided between the engine and the power transmission path and switched between an engaged condition in which the engine is connected to the power transmission path and a disengaged condition in which the engine is disconnected from the power transmission path; and a damping controller for controlling the friction clutch to a slip condition so that damping torque is transmitted from the travel motor to the engine when the starter motor is driven in order to start the engine in a motor travel condition in which the travel motor is driven.

Preferably, the damping controller of the control apparatus for a hybrid vehicle controls the friction clutch to the slip condition so that the damping torque is transmitted from the travel motor to the engine when a vibration frequency of the engine during engine startup passes at least one of a resonance frequency of a power unit including the engine and the travel motor and a resonance frequency of a vehicle body provided with the power unit.

According to the present invention, when the engine is started by driving the starter motor, the friction clutch is controlled to the slip condition such that the damping torque is transmitted from the travel motor to the engine. In so doing, a reaction force generated when the engine is caused to start rotating can be canceled out by the damping torque, and as a result, engine vibration, and therefore vehicle body vibration, can be suppressed. Further, the engine is caused to start rotating using the starter motor while engine vibration is suppressed using the travel motor, and therefore vibration during engine startup can be suppressed while avoiding an increase in the size of the travel motor.

### BRIEF DESCRIPTION OF THE DRAWINGS

FIG. 1 is a schematic diagram showing a power unit installed in a hybrid vehicle;

FIGS. 2A to 2C are illustrative views showing processes for switching from an EV mode to an HEV mode;

FIG. 3 is a diagram showing examples of a variable torque of an engine, which is generated during cranking, a damping torque for canceling out the variable torque, and a motor torque output from a motor/generator; and

FIG. 4A is an illustrative view showing a variation condition between an engine rotation speed and a motor rotation speed when damping control is not implemented, while FIG. 4B is an illustrative view showing a variation condition between the engine rotation speed and the motor rotation speed when the damping control is implemented.

### DESCRIPTION OF THE PREFERRED EMBODIMENTS

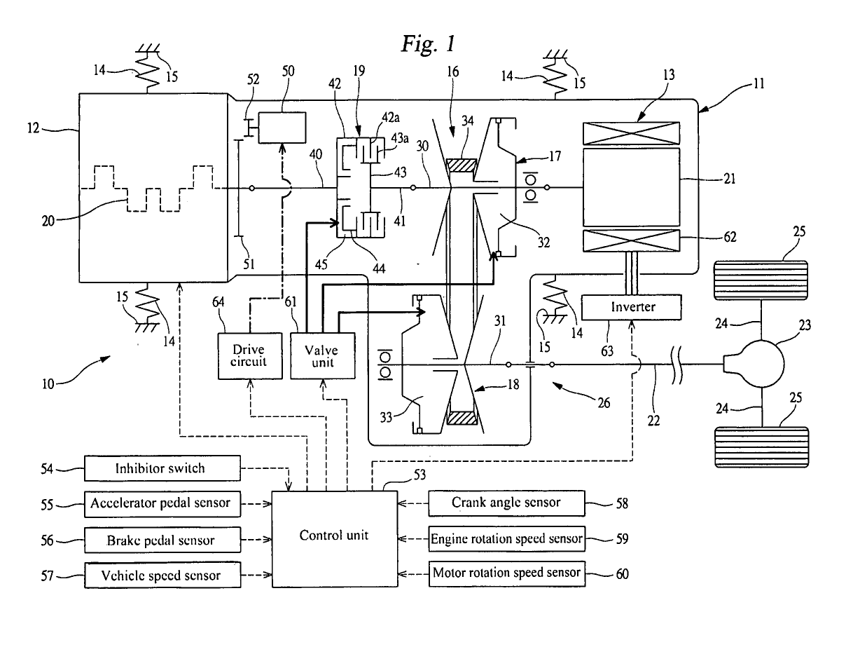

An embodiment of the present invention will be described in detail below on the basis of the drawings. FIG. 1 is a schematic diagram showing a power unit 11 installed in a hybrid vehicle 10. As shown in FIG. 1, the power unit 11, which is also known as a power train or a power plant, includes an engine 12 and a motor/generator (a travel motor) 13 as power sources. Further, a plurality of mount components 14 are attached to the power unit 11, and the power unit 11 is supported on a vehicle body 15 via the mount components 14. The power unit 11 also includes a continuously variable transmission 16, and the continuously variable transmission 16 includes a primary pulley 17 and a secondary pulley 18. A crankshaft 20 of the engine 12 is coupled to one side of the primary pulley 17 via a friction clutch 19, and a rotor 21 of the motor/generator 13 is coupled to another side of the primary pulley 17. Drive wheels 25 are coupled to the secondary pulley 18 via a propeller shaft 22, a differential mechanism 23, a drive shaft 24, and so on.

Hence, the motor/generator 13 and the drive wheels 25 are connected via a power transmission path 26 constituted by the continuously variable transmission 16, the propeller shaft 22, the differential mechanism 23, the drive shaft 24, and so on. In other words, power is transmitted from the motor/generator 13 to the drive wheels 25 via the power transmission path 26. Further, the engine 12 and the drive wheels 25 are connected via the friction clutch 19 and the power transmission path 26. More specifically, the friction clutch 19 is provided between the engine 12 and the power transmission path 26, and by disengaging the friction clutch 19, the engine 12 can be disconnected from the power transmission path 26 so that only the motor/generator 13 is connected to the drive wheels 25 as a power source. By engaging the friction clutch 19, on the other hand, the engine 12 can be connected to the power transmission path 26 so that both the motor/generator 13 and the engine 12 are connected to the drive wheels 25 as power sources.

The continuously variable transmission 16 includes a primary shaft 30 and a secondary shaft 31 that is parallel to the primary shaft 30. The primary pulley 17 is provided on the primary shaft 30, and a primary oil chamber 32 is defined on a back surface side of the primary pulley 17. Further, the secondary pulley 18 is provided on the secondary shaft 31, and a secondary oil chamber 33 is defined on a back surface side of the secondary pulley 18. Furthermore, a drive chain 34 is wound around the primary pulley 17 and the secondary pulley 18. By adjusting an oil pressure in the primary oil chamber 32 and the secondary oil chamber 33, a pulley groove width can be varied, and as a result, a winding diameter of the drive chain 34 can be varied.

The friction clutch 19 includes a clutch input shaft 40 coupled to the crankshaft 20 of the engine 12, and a clutch output shaft 41 coupled to the primary shaft 30 of the primary pulley 17. A clutch drum 42 including a friction plate 42a is coupled to the clutch input shaft 40, and a clutch hub 43 including a friction plate 43a is coupled to the clutch output shaft 41. Further, a piston 44 is incorporated into the clutch drum 42, and an engagement oil chamber 45 is defined on a back surface side of the piston 44. By supplying working oil to the engagement oil chamber 45, the piston 44 can be caused to move in an engagement direction such that the friction plates 42a, 43a are pressed against each other. In so doing, the friction clutch 19 can be switched to an engaged condition. By discharging the working oil from the engagement oil chamber 45, on the other hand, the piston 44 can be caused to move in a disengagement direction by a spring, not shown in the drawing, such that the friction plates 42a, 43a are separated. In so doing, the friction clutch 19 can be switched to a disengaged condition. Furthermore, by adjusting a pressure of the working oil supplied to the engagement oil chamber 45, the friction clutch 19 can be controlled to a slip condition. Note that the slip condition of the friction clutch 19 is a so-called half clutch condition in which the friction plates 42a, 43a are not completely engaged. In other words, the slip condition of the friction clutch 19 is a condition in which the clutch input shaft 40 and the clutch output shaft 41 rotate such that a rotation speed difference is generated therebetween.

The power unit 11 is also provided with a starter motor 50 for causing the engine 12 to start rotating (i.e. for cranking the engine 12). A ring gear 51 is fixed to the crankshaft 20 of the engine 12, and a pinion gear 52 that meshes with the ring gear 51 is provided on the starter motor 50. When the starter motor 50 is energized, the pinion gear 52 projects while rotating so as to mesh with the ring gear 51, and thus the ring gear 51 can be rotated by the pinion gear 52. Note that a normally meshed starter motor that meshes with the ring gear 51 via a one-way clutch may also be used as the starter motor 50. Further, an alternator may be caused to function as the starter motor 50.

The hybrid vehicle 10 is also provided with a control unit 53 that controls the engine 12, the motor/generator 13, the friction clutch 19, the starter motor 50, the continuously variable transmission 16, and so on. An inhibitor switch 54 that detects an operating condition of a select lever, an accelerator pedal sensor 55 that detects an operating condition of an accelerator pedal, a brake pedal sensor 56 that detects an operating condition of a brake pedal, a vehicle speed sensor 57 that detects a vehicle speed, a crank angle sensor 58 that detects a crank angle (a rotation angle of the crankshaft 20), an engine rotation speed sensor 59 that detects an engine rotation speed (a rotation speed of the crankshaft 20), a motor rotation speed sensor 60 that detects a motor rotation speed of the motor/generator 13 (a rotation speed of the rotor 21), and so on are connected to the control unit 53. The control unit 53 determines a vehicle condition on the basis of information from the various sensors and so on, and outputs control signals to the engine 12, the motor/generator 13, and so on. The control unit 53 includes a CPU that calculates the control signals and so on, a ROM that stores a control program, calculation formulae, map data, and so on, and a RAM that stores data temporarily.

The hybrid vehicle 10 is provided with a valve unit 61 including a plurality of solenoid valves to control a supply of working oil from an oil pump, not shown in the drawing, to the friction clutch 19, the continuously variable transmission 16, and so on. The control unit 53 controls the operating conditions of the friction clutch 19 and the continuously variable transmission 16 by outputting a control signal to the valve unit 61. Further, a high voltage battery, not shown in the drawing, is connected to a stator 62 of the motor/generator 13 via an inverter 63 in order to control a supply of power to the motor/generator 13. The control unit 53 controls the torque and rotation speed of the motor/generator 13 by outputting a control signal to the inverter 63. Furthermore, a low voltage battery, not shown in the drawing, is connected to the starter motor 50 via a drive circuit 64 in order to control a supply of power to the starter motor 50. The control unit 53 controls the operating condition of the starter motor 50 by outputting a control signal to the drive circuit 64. The control unit 53 also outputs control signals to an injector, an igniter, a throttle valve, and so on, none of which are shown in the drawing, to control the torque and rotation speed of the engine 12.

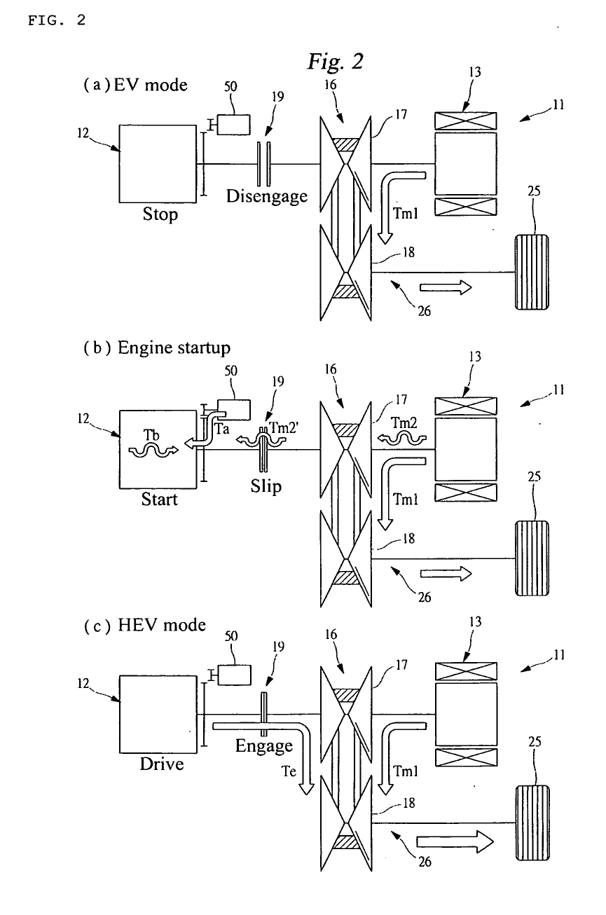

FIGS. 2A to 2C are illustrative views showing processes for switching from an EV mode to an HEV mode. Here, as shown in FIG. 2A, the EV mode is a travel mode in which the motor/generator 13 alone is connected to the drive wheels 25 as a power source by switching the friction clutch 19 to the disengaged condition. The EV mode is executed in a low vehicle speed region, a low accelerator opening region, or the like in which a driving force required by a driver is small, and in the EV mode, the engine 12 is disconnected from the power transmission path 26 and stopped. The HEV mode, meanwhile, as shown in FIG. 2C, is a travel mode in which the engine 12 is connected to the drive wheels 25 as a power source in addition to the motor/generator 13 by starting the engine 12 and switching the friction clutch 19 to the engaged condition. The HEV mode is executed in a high vehicle speed region, a high accelerator opening region, or the like in which the driving force required by the driver is large, and in the HEV mode, both the engine 12 and the motor/generator 13 are driven. Note that in the HEV mode, it is possible to transmit only an engine torque Te to the drive wheels 25 by controlling the motor/generator 13 to a racing condition.

When a vehicle speed increase, an accelerator opening increase, or the like exceeding a predetermined value is detected during travel in the EV mode, or in other words in a motor travel condition, cranking of the engine 12 is started by driving the starter motor 50 in order to shift from the EV mode to the HEV mode. When the engine 12 is started, the engine rotation speed is synchronized with the motor rotation speed, whereupon the friction clutch 19 is switched to the engaged condition, thereby completing the switch from the EV mode to the HEV mode. A determination as to whether or not to switch the travel mode is made on the basis of the vehicle speed, the accelerator opening, and so on, for example, and therefore the engine 12 is switched between stoppage and startup frequently during travel. When the engine is started, however, the engine itself is caused to vibrate by load variation during cranking, and this vibration propagates from the engine 12 to the vehicle body 15 via the mount components 14 and so on. It is therefore important to suppress engine vibration during engine startup.

Damping control for suppressing engine vibration during engine startup will be described below. As shown in FIG. 2B, when it is determined that a switch from the EV mode to the HEV mode is required, the control unit 53 outputs a drive signal to the starter motor 50 such that the engine 12 is cranked by a starting torque Ta of the starter motor 50. The control unit 53, functioning as damping controller, then causes the motor/generator 13 to generate a damping torque Tm2 in addition to a travel torque Tm1 to be transmitted to the drive wheels 25, and controls the friction clutch 19 to the slip condition such that a damping torque Tm2′ is transmitted from the motor/generator 13 to the engine 12.

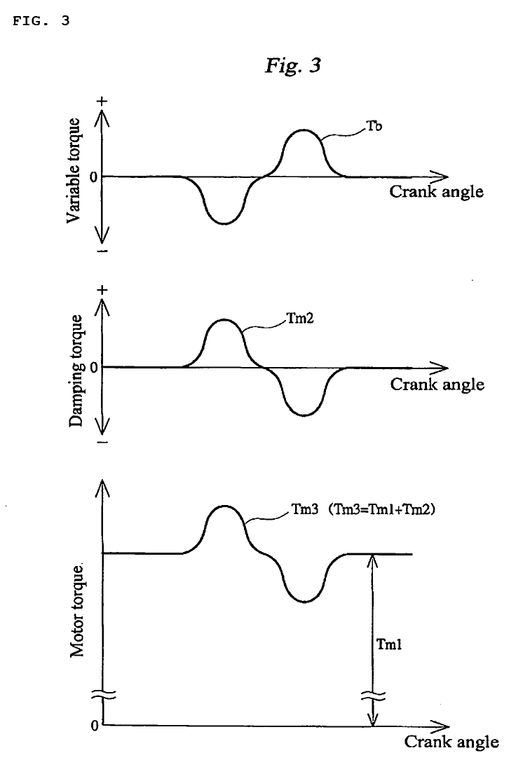

FIG. 3 is a diagram showing examples of a variable torque Tb of the engine 12, which is generated during cranking, the damping torque Tm2 for canceling out the variable torque Tb, and a motor torque Tm3 output from the motor/generator 13. As shown in FIG. 3, a reaction force, or in other words the variable torque Tb, is generated in the engine 12 during cranking in accordance with the crank angle. More specifically, during a compression stroke, the variable torque Tb is generated in a direction (a − direction in FIG. 3) for suppressing a rotation speed of the cranking, and in an expansion stroke, the variable torque Tb is generated in a direction (a + direction in FIG. 3) for assisting the rotation speed of the cranking. The damping torque Tm2 of the motor/generator 13 is set in an opposite direction to the variable torque Tb in order to cancel out the variable torque Tb. More specifically, during the compression stroke, the damping torque Tm2 is set in the direction (the + direction in FIG. 3) for assisting the rotation speed of the cranking, whereas in the expansion stroke, the damping torque Tm2 is set in the direction (the − direction in FIG. 3) for suppressing the rotation speed of the cranking. The motor/generator 13 outputs the motor torque Tm3, which is obtained by adding together the travel torque Tm1a to be transmitted to the drive wheels 25 and the aforesaid damping torque Tm2, whereby the damping torque Tm2′ is transmitted from the motor/generator 13 to the engine 12 via the friction clutch 19 in the slip condition. Hence, the variable torque Tb of the engine 12 can be canceled out by the damping torque Tm2′, leading to a reduction in a vibratory force of the engine 12, and as a result, engine vibration, and therefore vehicle body vibration, can be suppressed. Moreover, the starting torque Ta is transmitted from the starter motor 50 to the engine 12 while the damping torque Tm2 is transmitted from the motor/generator 13 to the engine 12. As a result, a sensation of deceleration occurring during engine startup due to a torque deficiency can be prevented, and an increase in the size of the motor/generator 13 can be avoided.

Furthermore, by controlling the friction clutch 19 to the slip condition during the damping control, a part of the motor torque Tm3 is transmitted from the motor/generator 13 to the engine 12 as the damping torque Tm2′. Hence, although the damping torque Tm2 generated by the motor/generator 13 and the damping torque Tm2′ transmitted to the engine 12 via the friction clutch 19 do not always match each other in magnitude, the magnitude of the damping torque Tm2′ increases and decreases in conjunction with the damping torque Tm2. The variable torque Tb can therefore be canceled out using the damping torque Tm2′, and as a result, engine vibration during engine startup can be suppressed. Needless to mention, the magnitude and timing of the damping torque Tm2 output from the motor/generator 13 are controlled such that the damping torque Tm2′ transmitted via the friction clutch 19 cancels out the variable torque Tb generated during engine startup.

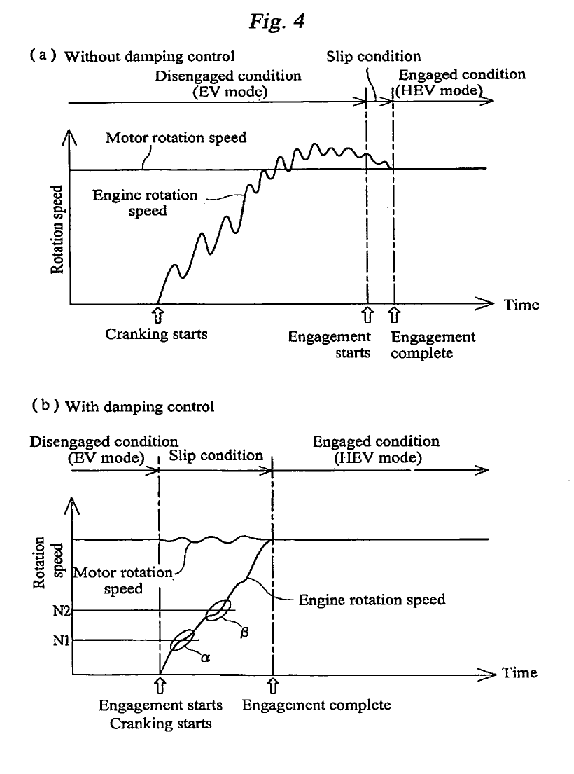

FIG. 4A is an illustrative view showing a variation condition between the engine rotation speed and the motor rotation speed when the damping control is not implemented. FIG. 4B is an illustrative view showing a variation condition between the engine rotation speed and the motor rotation speed when the damping control is implemented. As shown in FIG. 4A, when the damping control is not implemented using the motor/generator 13 and the friction clutch 19, or in other words when the engine 12 is started while leaving the friction clutch 19 disengaged, the variable torque Tb generated during cranking is large, and as a result, the engine rotation speed varies such that engine vibration is generated. As shown in FIG. 4B, on the other hand, when the damping control is implemented using the motor/generator 13 and the friction clutch 19, or in other words when the friction clutch 19 is controlled to the slip condition while causing the motor/generator 13 to generate the damping torque Tm2, the variable torque Tb generated during cranking can be reduced, and as a result, the engine rotation speed increases smoothly, leading to a reduction in engine vibration. By reducing engine vibration in this manner, a reduction can be achieved in the vibration that propagates from the engine 12 to the vehicle body 15, and as a result, passenger discomfort during engine startup can be eliminated.

Engine vibration may be suppressed by implementing the damping control continuously from the start of cranking to a point at which the engine 12 reaches a state of complete explosion. However, it is sufficient to ensure that the damping control is underway when a vibration frequency of the engine 12 passes through a resonance frequency of the power unit 11 or the vehicle body 15. More specifically, by implementing the damping control for transmitting the damping torque Tm2′ to the engine 12 when the vibration frequency of the engine 12 caused to vibrate by the variable torque Tb passes through the resonance frequency of the power unit 11, vibration of the power unit 11 leading to vehicle body vibration can be suppressed effectively. Further, by implementing the damping control for transmit the damping torque Tm2′ to the engine 12 when the vibration frequency of the engine 12 passes through the resonance frequency of the vehicle body 15, vehicle body vibration leading to passenger discomfort can be suppressed effectively. Note that the vibration frequency of the engine 12 caused to vibrate by the variable torque Tb is linked to a variation period of the variable torque Tb, or in other words the engine rotation speed. As shown in FIG. 4B, for example, when an engine rotation speed N1 corresponds to the resonance frequency of the power unit 11, vibration of the power unit 11 can be suppressed effectively by implementing the damping control within a range indicated by a symbol a. Further, when an engine rotation speed N2 corresponds to the resonance frequency of the vehicle body 15, for example, vibration of the vehicle body 15 can be suppressed effectively by implementing the damping control within a range indicated by a symbol β.

The present invention is not limited to the embodiment described above, and may be subjected to various modifications within a scope that does not depart from the spirit thereof. In the above description, the power transmission path 26 includes the continuously variable transmission 16, the propeller shaft 22, the differential mechanism 23, the drive shaft 24, and so on, but the present invention is not limited thereto, and a transmission such as the continuously variable transmission 16 maybe omitted from the power transmission path 26, for example. Further, the engine 12 is directly coupled to the friction clutch 19 in the drawing, but the present invention is not limited thereto, and a torque converter may be disposed between the engine 12 and the friction clutch 19. Furthermore, the friction clutch 19 is not limited to the hydraulic clutch shown in the drawing, and may instead be an electromagnetic clutch controlled using electromagnetic force. Note that a direct current motor is used as the starter motor 50, but the present invention is not limited thereto, and an alternating current motor may be used as the starter motor 50. Moreover, an alternating current motor is used as the travel motor, but the present invention is not limited thereto, and as long as the damping torque Tm2 can be controlled, a direct current motor may be used as the travel motor instead.

What is claimed is:

1. A control apparatus for a hybrid vehicle in which a drive wheel is driven using an engine and a travel motor, the control apparatus comprising:
a starter motor to cause said engine to start rotating;
a power transmission path to transmit power from said travel motor to said drive wheel;
a friction clutch provided between said engine and said power transmission path and switched between an engaged condition in which said engine is connected to said power transmission path and a disengaged condition in which said engine is disconnected from said power transmission path; and
a damping controller for controlling said friction clutch to a slip condition so that damping torque is transmitted from said travel motor to said engine when said starter motor is driven in order to start said engine in a motor travel condition in which said travel motor is driven.

2. The control apparatus for a hybrid vehicle according to claim 1, wherein said damping controller controls said friction clutch to said slip condition so that said damping torque is transmitted from said travel motor to said engine when a vibration frequency of said engine during engine startup passes at least one of a resonance frequency of a power unit including said engine and said travel motor and a resonance frequency of a vehicle body provided with said power unit.
